(19) United States
(12) Patent Application Publication
(10) Pub. No.: US 2013/0344372 A1
(43) Pub. Date: Dec. 26, 2013

(54) STRESS RELIEF BODY TO PREVENT CELL SEAL FAILURE DURING ASSEMBLY

(71) Applicant: Steve Carkner, Ottawa (CA)

(72) Inventor: Steve Carkner, Ottawa (CA)

(21) Appl. No.: 14/004,078

(22) PCT Filed: Mar. 6, 2012
(86) PCT No.: PCT/IB2012/051036

§ 371 Date: Sep. 9, 2013

Related U.S. Application Data
(60) Provisional application No. 61/450,498, filed on Mar. 8, 2011.

(51) Int. Cl. H01M 2/08; H01M 2/02

(52) U.S. Cl. CPC H01M 2/08; H01M 2/026
USPC 429/127; 29/623.2

(57) ABSTRACT

A stress relief body is described for maintaining a safe bend radius on the seal of a pouch cell to prevent crimping of the cell covers and other damage. When the seal area of the cell pouch is folded to reduce the overall size of the resulting battery pack the stress relief body is integrated with the pouch cell to maintain the safe bend radius.

### TECHNICAL FIELD

This invention pertains to the field of batteries, and particularly to a stress relief body used to assemble individual pouch based cells for integration into a final battery pack assembly.

### BACKGROUND ART

### Disclosure of Invention

### Technical Problem

A battery is generally constructed from one or more individual electrochemical cells. Such cells may be manufactured using a variety of systems including metal cylinders such as industry standard ‘AA’ batteries or plastic jars such as the lead-acid batteries found in automobiles.

Pouch cells are generally constructed by enclosing a flat laminate structure of electrodes within a pouch which is then sealed. These pouch cells may be referred to in the industry as polymer cells, flat cells or laminate cells.

Pouch cell technology may also be applied in other areas such as the construction of super-capacitors.

The primary advantages of pouch cells are their ease of manufacturing and their volumetric efficiency due to the flat nature of the cells which allows many cells to be stacked together.

The primary disadvantage of pouch cells is maintaining an adequate seal when the pouch is closed. This is particularly seen over long periods of time and at elevated temperatures or pressures.

Cell manufacturing companies have invested considerable resources improving the quality and durability of the pouch seal process. However, in many cases this has led to the seal area growing larger which can impact the volumetric efficiency of the cell.

Cells are often integrated into final battery packs by companies other than those that manufactured the cell. Many of the problems associated with cell seal failure can be traced back to the way the cells were handled and packaged into the final battery assembly. The cell seal area is often folded against the side of the cell in order to reduce the overall footprint of the cell, such folding action can damage the pouch material and lead to premature failure of the cell months or even years after manufacturing is completed.

US Patent Application 2009/0258290, Lee et. al. describes a typical folding operation (FIGS. 4 and 5, item 23) which may cause considerable damage to the cells. The focus of Lee is on the insulation of the conductive seal edges, but serves to show the existing state of the art with respect to the folding methods used in the seal area.

Details on cell corrosion and failure of the seal area for a variety of pouch cells can be found in NASA report NASA/TM-2010-216727/Volume I, NESC-RP-08-75, August 2010.

There remains a need for a stress relief body to improve the way the seal area of a pouch cell is handled in manufacturing that improves volumetric efficiency of the overall battery pack without compromising the seal area of the individual cells. There is also a need to improve the repeatability and quality of the seal folding operation such that the process is repeatable by machine or by hand operated equipment.

### Technical Solution

In order to overcome the deficiencies noted above, we propose as a solution our invention, namely, a stress relief body which is designed to fit a specific pouch cell profile such that the seal area is not damaged during folding operations.

In another embodiment of the invention, the stress relief body may be constructed from compliant material such as foam bead which performs the same function of preventing damage to the cell seal area during battery assembly processes.

In another embodiment of the invention there is provided an electro-chemical storage cell comprising a flexible containment envelope forming a pocket comprising walls rising vertically from a base. The pocket contains a suitable amount of electro-chemically active material. A seal area extends horizontally from the base. There are at least two conductive connections penetrating the pocket into contact with the electro-chemically active material for providing a path for energy to travel into and out of the cell. The stress relief body is disposed upon the seal area and substantially adjacent to the base thereby minimizing stresses in the envelope at folds in the seal area when folded upon the stress relief body in an effort to maximize cell volumetric efficiency.

In a further embodiment of the invention the stress relief body is molded from a suitable low durometer elastic material such as a polyurethane material. One example is a foam material.

In yet another embodiment the stress relief body is coated with an adhesive so that the seal area adheres to the stress relief body when folded upon it.

In still another embodiment the stress relief body has a substantially triangular cross-sectional shape. The substantially triangular cross-sectional shape comprises an apex, a base, a vertical side, an angled side, a first rounded corner between the base and the angled side and a second rounded corner between the base and the vertical side. The vertical side is substantially longer than the base.

In one embodiment when the stress relief body is disposed upon the seal, the second rounded corner is nested within the base and the vertical side is in contact with the pocket vertical walls so that a smooth transition is defined around the second rounded corner between the vertically rising pocket walls and the horizontally extending seal area thereby ensuring any stress generated in the envelope when the seal area is folded during cell manufacture is distributed around the transition to avoid cracks, kinks and weakened areas. Similarly, when the seal area is folded around the first rounded corner and over the angled side the stress generated in the envelope when the seal area is folded during cell manufacture is distributed.

In another embodiment the stress relief body is injection molded specifically for a given size of cell.

In yet another embodiment the stress relief body is extruded around the base of the cell as the cell is manufactured.

In another embodiment of the invention there is disclosed a method of delivering stress relief to an electro-chemical storage cell during manufacture comprising the following steps:

a. Forming an electro-chemical storage cell having a base, substantially vertical walls rising from the base and a seal area having a distal end and extending horizontally from said base;

b. Forming a stress relief body from a suitable low durometer elastic material having a substantially triangular cross-section with an apex, a first rounded corner between a base and an angled side and a second rounded corner between the base and a vertical side;

c. Disposing the stress relief body upon the seal area and around the base so that the vertical side is adjacent the substantially vertical walls and the second rounded corner is nested within the base;

d. Folding the seal area around the second rounded corner so that there is a smooth transition between the substantially vertical walls and the horizontal seal area;

e. Folding the seal area around the first rounded corner so that there is a smooth transition between the horizontal seal area and the first angled side of the stress relief body; and,

f. Fixing by fixing means said distal tip of the seal area to the substantially vertical walls.

### Advantageous Effects

### DESCRIPTION OF DRAWINGS

FIG. 1 shows a top and side view of a typical prior art pouch cell design prior to battery pack assembly.

FIG. 2 shows a cross-section of a prior art cell seal area for a pouch cell.

FIG. 3 shows a cross-section of a prior art cell seal area when folded using conventional methods.

FIG. 4 shows one embodiment of the invention in cross-section showing a stress relief body member prior to folding of the seal area thereupon.

FIG. 5 shows the embodiment of the invention in FIG. 4 in cross-section in a final folded state.

FIG. 6 shows the embodiment of FIG. 5 in top view and side view for a pouch cell prior to folding.

FIG. 7 shows another embodiment of the invention.

### BEST MODE

### Mode for Invention

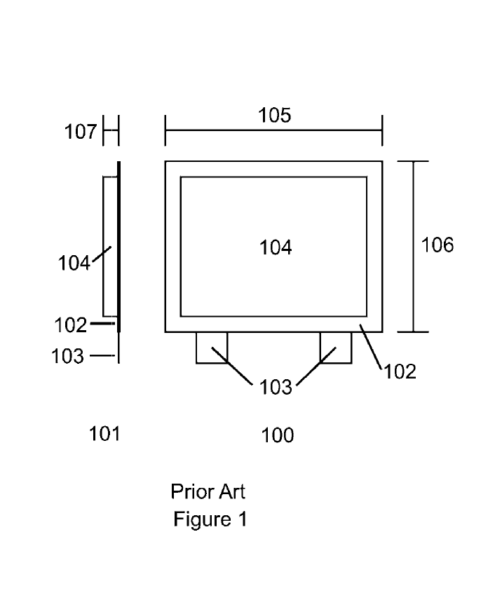

Referring to FIG. 1, a prior art pouch cell is shown in top view (100) and side view (101). The pouch cell has a pocket area (104) which generally contains active materials that could contain lithium polymer, nickel cadmium, iron phosphate, or other electro chemical structures for storing energy. The pouch cell has a seal area (102) which may be formed on all four sides of the cell, or may exist on only three edges of the cell, depending on the manufacturing methods employed by the manufacturer of the pouch cell. The cell includes at least two conductive connections (103) to provide a path for energy to travel in and out of the pouch cell.

In FIG. 1, the width (105), height (106) and thickness (107) of the pouch cell could be multiplied together to provide an overall volume that is required to house the cell. If this cell was constructed into a rectangular battery package, the volume of the package would need to be at least as large as this overall volume. The volumetric efficiency of a battery pack is calculated based on the amount of energy stored in a given volume. Therefore, the volume taken up by the seal area (102) is considered wasted space and leads to a reduction in overall volumetric efficiency. Battery pack assemblers generally seek to reduce the battery pack size and thereby increase the volumetric efficiency by folding the seal area (102) against the side of the pocket area (104).

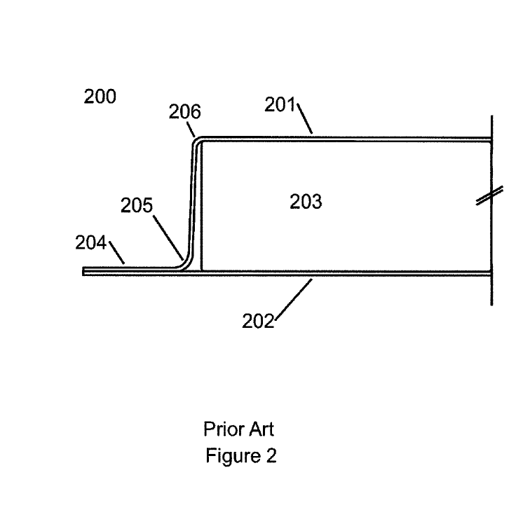

In FIG. 2, a cross sectional close-up view of a prior art cell seal area is shown. The pouch cell (200) includes the pocket (203) where the active material is stored. The pouch itself is made from two layers of material, often coated aluminum foil, with a top layer (201) and bottom layer (202). Some manufacturers use two separate foils for the top and bottom layer, other manufacturers may use a single piece of foil that is folded back on itself at one end of the cell. In either case, it is necessary to bond the top layer (201) to the bottom layer (202) in the cell seal area (204). This may be done by chemical adhesive, by thermally activated bonding agents, by welding or by mechanical force. There is generally a radius at the top edge (206) and bottom edge (205) of the foil as it bends around the pocket (203). Cell manufacturers pay close attention to these areas to ensure the foil layers are not damaged during cell production.

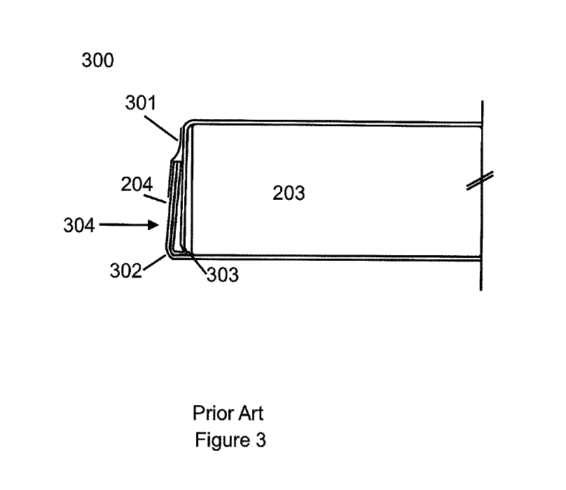

In FIG. 3, a prior art folded pouch (300) cross sectional close-up view of the cell seal area is shown with the seal (204) folded against the pocket (203). Generally, battery pack manufacturers will fold the cell seal area tightly against the pocket (203) and will often apply tape (301) to the cell to hold the edges in place. Crimping, creasing and other damage can occur where the foil is folded both inside (303) and outside (302) the cell. In these areas the foil is subjected to very high point stresses which can cause cracking of the foil to occur. In addition, the foil is generally treated with insulating materials to ensure that chemicals contained in the active cell materials stored in the pocket (203) do not cause corrosion or otherwise react with the foil materials that are used to construct the pouch for the cell. Testing at NASA has shown that corrosion in cell seal areas occurred at various rates for Lithium Polymer Cells from a variety of manufacturers.

When the folded cell structure is placed inside a battery pack housing, other forces may press against the seal area. These forces may apply pressure towards the stressed fold (304) resulting in additional cracking, tighter radii, and inconsistent quality of the final pack. The folding operation is often done by hand during assembly. The slight manufacturing variation in the size of the cells, the variation in handling of the cells from one worker to another, and the mechanical tolerances of the outer housing of the battery pack itself will all contribute to inconsistent quality and can lead to premature failure, often caused by corrosion at weak-spots in the foil materials.

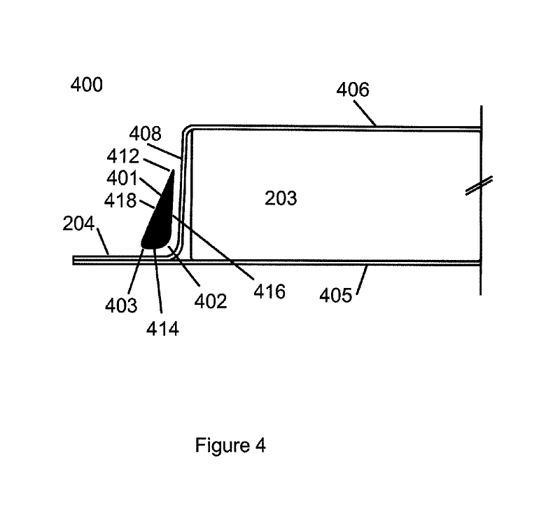

FIG. 4 shows a close up cross section of one embodiment of the cell structure (400) including a stress relief body (401). Stress relief body (401) is constructed with a radius on the inside edge (402) and the outside edge (403). The stress relief body (401) is moved into position against the pocket (203) of the cell. FIG. 4 shows the stress relief body (401) as it is being moved into position, with a large gap (402a) between the stress relief body (401) and the pocket (203). This is done for clarity and normally the stress relief body would be moved into position in contact with the cell.

The stress relief body (401) may be injection molded specifically for a given cell size. It may also be formed through an extrusion process as a single element that is cut and bent around the cell. The stress relief body may be made of low durometer material such as foam material that takes the shape and existing radius of the cell as it is pressed into place. A self-adhesive layer may be added to coat the stress relief body to eliminate the need for tape or other adhesives to hold the stress relief body in place.

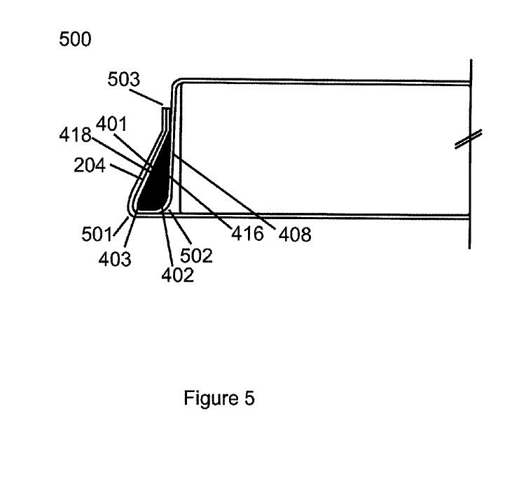

FIG. 5 shows a completed cell assembly (500) with the cell seal area (204) folded over the stress relief body (401) completely enclosing it. Radii on the inside (502) and outside (501) of the cell seal area (204) are maintained by the curves of the stress relief body which ensures consistent quality. The envelope (204) will not form any pressure points, creases or other weak spots where cracking and corrosion can occur.

The folded seal area (204) may be held in place with tape (not shown) at its distal end (503) or may be held in place through a self-adhesive layer that could be applied to the stress relief body (401) or to the surface of the seal area (204). Once formed, the stress relief body has the added advantage that side impacts to the cell will be spread out and absorbed by the elastic material of the stress relief body rather than being directly applied to the active material inside the pouch pocket.

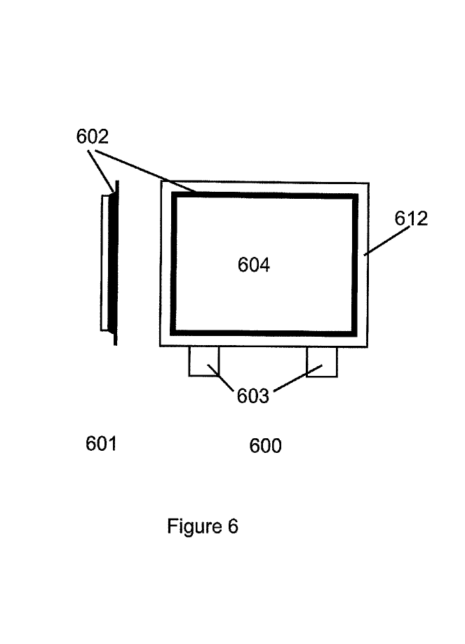

FIG. 6 shows a top view (600) and side view (601) of another embodiment of a pouch cell (604) with an example of the stress relief body (602) in place. The stress relief body (602) is placed around the pocket (604) of the cell. The pouch cell (604) shown has seal areas (612) on all four sides. For cells with three seal areas, or for odd-shaped cells with rounded, polygonal or other shaped seal areas, an appropriate stress relief body can be constructed. It may also be desirable to not use a stress relief body at the cell connection tabs (603), or to have only a partial stress relief body in this area as the tabs are typically not folded or taped. The stress relief body itself may be made from one or more separate components while still remaining within the scope and intention of the invention.

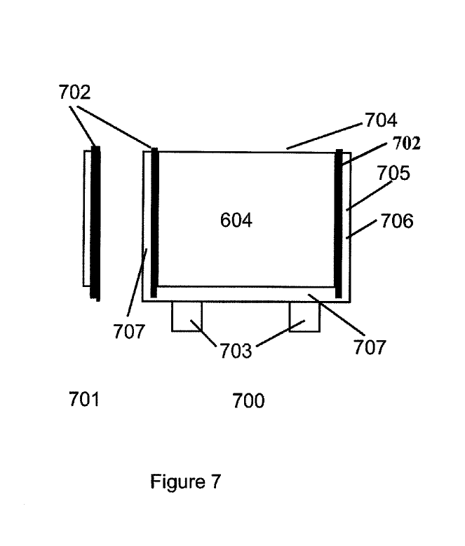

FIG. 7 shows a top view (700) and side view (701) of the embodiment described above where the stress relief body (702) lies on three sides of the pocket (604). In addition, the pouch cell shown does not have a seal area on one side; instead it is a folded side (704). In this type of cell, only one piece of foil is used to create the pouch, it is folded back on itself, which creates therefore the folded side (704). In the example shown, one side of the cell which contains the cell connection tabs (703) will not be folded and therefore the stress relief body is not present in this area. The stress relief body is only placed against a first side (707) and a second side (705) of the cell seal area (706).

Cells also exist that have connection tabs penetrating opposite sides of the cell, and some manufacturers may elect to only fold one, two, three or more cell seal areas. The stress relief body may be present, but not used. Therefore, it is reasonable that a continuous frame is placed around the cell pocket area, but the cell seal area is only folded against the stress relief on a limited number of sides.

Referring back to FIGS. 4 and 5, and in one embodiment of the invention, there is an electro-chemical storage cell (400) comprising a flexible containment envelope (406) forming a pocket (203) comprising walls (408) rising vertically from a concave bottom edge or base (405). The pocket (203) contains a suitable amount of electro-chemically active material. The storage cell includes a seal area (204) extending horizontally from the base (405). As exemplified by FIG. 1, there are at least two conductive connections (not shown in FIGS. 4 and 5) penetrating the pocket (203) into contact with the suitable amount of electro-chemically active material for providing a path for energy to travel into and out of the cell. There is further included a stress relief body (401) disposed upon the seal area (204) and substantially adjacent to the base (405). The stress relief body has the effect of minimizing stress in the envelope at folds in the seal area when folded upon said stress relief body to maximize cell volumetric efficiency as more fully described in FIG. 5.

The stress relief body (401) is molded from a suitable durometer material. In one embodiment of the invention the suitable durometer material is a soft and elastic polyurethane material. In another embodiment of the invention the polyurethane material is a foam material.

In one embodiment of the invention the surfaces of the stress relief body (401) is coated with an adhesive so that the seal area adheres to the stress relief body when folded thereupon as shown in FIG. 5.

As illustrated in FIG. 4, the stress relief body (401) has a substantially triangular cross-sectional shape comprising an apex (412), a base (414), a vertical side (416), an angled side (418), a first rounded corner (403) between the base and the angled side and a second rounded corner (402) between the base and the vertical side. In the embodiment illustrated in FIG. 4, the vertical side (416) is substantially longer than the base (414).

As shown in FIG. 5, when the stress relief body (401) is disposed upon the seal area (204), the second rounded corner (402) is nested within concavity (502) and the vertical side (416) is in contact with the pocket vertical walls (408) so that a smooth transition of the envelope is defined around rounded corner (402) between the vertically rising pocket walls (408) and the seal area (204) thereby ensuring a stress generated in the envelope when the seal area is folded during cell manufacture is distributed to avoid damage. When the seal area (204) is folded around rounded corner (403) of the stress relief body (401) and over the angled side (418) the stress generated in the envelope when the seal area is folded during cell manufacture is distributed to avoid damage. The relief body may be injection molded specifically for a given size of cell or in the alternative the stress relief body may be extruded around the base of the cell as the cell is manufactured.

A method of delivering stress relief to an electro-chemical storage cell during manufacture comprises the following steps:

a. Forming the electro-chemical storage cell having a base, substantially vertical walls rising from the base and a seal area having a distal end and extending horizontally from the base;

b. Forming a stress relief body from a suitable durometer material having a substantially triangular cross-section with an apex, a first rounded corner between a base and an angled side and a second rounded corner between the base and a vertical side;

c. Disposing the stress relief body upon the seal area and around the base so that said vertical side is adjacent said substantially vertical walls and the second rounded corner is nested within the base;

d. Folding the seal area around the second rounded corner so that there is a smooth transition between the substantially vertical walls and the horizontal seal area;

e. Folding the seal area around the first rounded corner so that there is a smooth transition between the horizontal seal area and the first angled side of the stress relief body; and,

f. Fixing by fixing means the distal tip of the seal area to the substantially vertical walls.

The method may further comprise the step of injection molding the stress relief body specifically for a given size of cell. The method may alternatively comprise the step of extruding the stress relief body around the base of the cell as the cell is manufactured.

Although the description above contains much specificity, these should not be construed as limiting the scope of the invention but as merely providing illustrations of the presently preferred embodiment of this invention. Thus the scope of the invention should be determined by the appended claims and their legal equivalents.

### INDUSTRIAL APPLICABILITY

### SEQUENCE LIST TEXT

[symbol]

1. An electro-chemical storage cell comprising:
a. a flexible containment envelope forming a pocket comprising walls rising vertically from a base;
b. said pocket containing a suitable amount of electro-chemically active material;
c. a seal area extending horizontally from said base;
d. at least two conductive connections penetrating the pocket into contact with said suitable amount of electro-chemically active material for providing a path for energy to travel into and out of the cell; and,
e. a stress relief body disposed upon said seal area and substantially adjacent to the base thereby minimizing stresses in the envelope at folds in the seal area when folded upon said stress relief body to maximize cell volumetric efficiency.

2. The cell of claim 1 wherein the stress relief body is molded from a low durometer elastic material.

3. The cell of claim 2 wherein said suitable low durometer elastic material is a polyurethane material.

4. The cell of claim 3 wherein said polyurethane material is a foam material.

5. The cell of claim 1 wherein the stress relief body is coated with an adhesive so that the seal area adheres to the stress relief body when folded thereupon.

6. The cell of claim 1 wherein the stress relief body has a substantially triangular cross-sectional shape.

7. The cell of claim 6 wherein said substantially triangular cross-sectional shape comprises an apex, a base, a vertical side, an angled side, a first rounded corner between said base and said angled side and a second rounded corner between the base and said vertical side.

8. The cell of claim 7 wherein the vertical side is substantially longer than the base.

9. The cell of claim 8 wherein when the stress relief body is disposed upon the seal, the second rounded corner is nested within the base and the vertical side is in contact with said pocket vertical walls so that a smooth transition is defined around the second rounded corner between the vertically rising pocket walls and the horizontally extending seal area thereby ensuring a stress generated in the envelope when the seal area is folded during cell manufacture is distributed.

10. The cell of claim 9 wherein when the seal area is folded around said first rounded corner and over said angled side said stress generated in the envelope when the seal area is folded during cell manufacture is distributed.

11. The cell of claim 1 wherein the stress relief body is injection molded specifically for a given size of cell.

12. The cell of claim 1 wherein the stress relief body is extruded around the base of the cell as the cell is manufactured.

13. An electro-chemical storage cell comprising:
a. a flexible containment envelope forming a pocket comprising walls rising vertically from a base;
b. said pocket containing a suitable amount of electro-chemically active material;
c. a seal area extending horizontally from said base;
d. at least two conductive connections penetrating the pocket into contact with said suitable amount of electro-chemically active material for providing a path for energy to travel into and out of the cell; and, an adhesive coated and molded stress relief body disposed upon said seal area and substantially adjacent to the base thereby minimizing stresses in the envelope at folds in the seal area when folded upon said stress relief body to maximize cell volumetric efficiency.

14. The cell of claim 13 wherein the stress relief body has a substantially triangular cross-sectional shape comprising an apex, a base, a vertical side, an angled side, a first rounded corner between said base and said angled side and a second rounded corner between the base and said vertical side and wherein the vertical side is substantially longer than the base.

15. The cell of claim 14 wherein when the stress relief body is disposed upon the seal, the second rounded corner is nested within the base and the vertical side is in contact with said pocket vertical walls so that a smooth transition is defined around the second rounded corner between the vertically rising pocket walls and the horizontally extending seal area thereby ensuring a stress generated in the envelope when the seal area is folded during cell manufacture is distributed, and wherein when the seal area is folded around said first rounded corner and over said angled side said stress generated in the envelope when the seal area is folded during cell manufacture is distributed.

16. The cell of claim 15 wherein the stress relief body is injection molded specifically for a given size of cell.

17. The cell of claim 16 wherein the stress relief body is extruded around the base of the cell as the cell is manufactured.

18. A method of delivering stress relief to an electro-chemical storage cell during manufacture comprising the following steps:
a. Forming said electro-chemical storage cell having a base, substantially vertical walls rising from said base and a seal area having a distal end and extending horizontally from said base;
b. Forming a stress relief body from a suitable low durometer elastic material having a substantially triangular cross-section with an apex, a first rounded corner between a base and an angled side and a second rounded corner between said base and a vertical side;
c. Disposing said stress relief body upon said seal area and around said base so that said vertical side is adjacent said substantially vertical walls and said second rounded corner is nested within the base;
d. Folding the seal area around the second rounded corner so that there is a smooth transition between the substantially vertical walls and the horizontal seal area;
e. Folding the seal area around the first rounded corner so that there is a smooth transition between the horizontal seal area and the first angled side of the stress relief body; and,
f. Fixing by fixing means said distal tip of the seal area to the substantially vertical walls.

19. The method of claim 18 further comprising the step of injection molding the stress relief body specifically for a given size of cell.

20. The method of claim 18 further comprising the step of extruding the stress relief body around the base of the cell as the cell is manufactured.
